(19) United States
(12) Patent Application Publication
(10) Pub. No.: US 2019/0103022 A1
(43) Pub. Date: Apr. 4, 2019

(54) PORTABLE REMOTELY OPERATED TRAFFIC CONTROL SIGNALS

(71) Applicant: ANDREW KELLY, EVANSTON, IL (US)

(72) Inventor: ANDREW KELLY, EVANSTON, IL (US)

(21) Appl. No.: 16/146,398

(22) Filed: Sep. 28, 2018

Related U.S. Application Data
(60) Provisional application No. 62/566,806, filed on Oct. 2, 2017.

(51) Int. Cl. G08G 1/0955

(52) U.S. Cl. CPC G08G 1/0955

(57) ABSTRACT

A portable wireless traffic-control signal system for safely directing vehicle and/or pedestrian traffic is disclosed. In a preferred embodiment, it includes a base, an adjustable-height vertical support, and a display module capable of displaying words and/or images. In a preferred embodiment, the system includes remote control capability so that safety personnel (e.g., police officer or crossing guard) may control the system from a location safely out of the path of traffic.

### PRIORITY

This application claims priority to U.S. Provisional Application 62/566,806 filed on Oct. 2, 2017, which is incorporated herein by reference in its entirety.

### BACKGROUND

### 1. Field of the Invention

The present disclosure relates to motor vehicle traffic control. More particularly, it relates to portable and remotely operated traffic signals.

William Phelps Eno, who never learned to drive, proposed placing stop signs at intersections in a 1900 article for Rider and Driver magazine. In 1911, the first centerline was drawn on a Michigan road. The first electric traffic signal was installed in Cleveland in 1915. Detroit is credited with installing the first proper stop sign that same year. Detroit policeman Lester Wire invented the first traffic signal as a two-color, red-and-green light, with a buzzer to warn pedestrians of pending light changes. In 1920, another policeman, William Potts, modified this basic design to include the tri-colored red, amber, and green lights widely used today. This simple, three-color icon has endured for nearly a century with relatively little change, save for the incorporation of modem technologies such as automatic timers, diode lights, and motion sensors.

In 1923, the Mississippi Valley Association of State Highway Departments developed a set of recommendations for street-sign shapes based on the idea that the more sides a sign has, the higher the danger level it invokes. The circle, with an infinite number of sides, represented the highest danger recommended for railroad crossings. The octagon denoted the second-highest level of danger for road crossings.

The Manual on Uniform Traffic Control Devices (hereinafter “Manual”), published by the Federal Highway Administration (hereinafter “FHWA”), is official manual for signage in the United States. The Manual is a national standard, intended to ensure that signage is consistent throughout the US. The Manual is developed and modified by FHWA through the Federal Register rule-making process.

In the United States, a STOP sign is a red octagonal with a white border and a reversed white colored “STOP” printed in the center. The standard size of a regular roadside STOP sign is 30×30 inches. A STOP sign means that vehicles must come to a full stop before proceeding. On divided highways, STOP signs for crossing or turning vehicles is often placed on the island or diving strip. Like other traffic signs, STOP signs are usually permanently secured on signposts and supports. Wood and steel are the two primary materials used for small sign supports. Larger sign supports, such as cantilever structures or sign bridges, are usually made of steel.

Sometimes it is useful to place a temporary STOP sign in areas such as schools, construction sites, street detours, parking lots, accident sites, and other locations. Usually, the signs are a smaller version of regular STOP signs with a short handle either hand-held by users or secured on a temporary stand such as a traffic cone. Due to the nature of the sign message and application locations, it is vital for drivers and pedestrians to notice the presence of mobile STOP signs. Mobile STOP signs must have very high visibility to demand attention due to their relatively small size, unusual locations and unexpected presence.

It is also common for police officers to have to stand in the center of an intersection and use hand signals to direct traffic. This subjects officers to risk of being struck by drivers due to inattention, intoxication, or other reasons. Similarly, crossing guards at school crossings must venture out into the road in front of approaching traffic to signal vehicles to stop and yield to young student pedestrians.

Most traffic signs are lit passively by reflecting the headlight from approaching vehicles. The signs are usually polished with retro reflective coating to increase the reflectivity of incoming light. There are different types of retro reflective surfaces such as basic reflective sheeting which is made of small glass beads, multi-layered reflective sheeting, micro-prismatic sheeting, etc., with different degrees of reflectivity. Regardless of coating materials, those traffic signs are only lit at night and/or during foggy conditions when approaching vehicles have their headlights on.

### 2. Related Art

Portable traffic light assemblies in the prior art are operable with an automatic control circuit or a manual switch, wherein the manual switch is usually located on the light assembly requiring an operator in the proximity. For example, U.S. Pat. No. 2,401,940 discloses a portable traffic signal including a base member having a telescoping extension member with a traffic signal unit thereon. U.S. Pat. No. 4,706,087 discloses a portable traffic signal including a base for mounting on the bed of a transporting vehicle and an articulated frame pivotally attached to the base that supports a traffic light. U.S. Pat. No. 4,777,751 discloses a portable illuminated signal station including a platform on which a person can stand, and a frame section attached thereto, wherein signs, lights and reflectors are supportable on the second frame.

U.S. Pat. No. 4,992,788 discloses a traffic control system including a trailer having a base supported by an axle and wheels and two signal supports which are extendable with a hydraulic cylinder. U.S. Pat. No. 5,400,019 disclose a portable traffic light including an adjustable tripod stand with a traffic light assembly secured thereto. The traffic lights are controlled with a control circuit including a programmable timer. U.S. Pat. No. 5,001,475 discloses a portable traffic control device including an upright human shaped figure with electrical back to back traffic signal units thereon, wherein the signals are controlled by an automatic controller.

U.S. Pat. No. 5,276,424 disclose portable, band-held traffic signal device such as for use at traffic intersections and school crossings, It includes a front, indicia-bearing sign portion for communicating traffic instructions to on-coming traffic; a handle portion coupled to a lower edge portion of the front indicia-bearing sign portion; and an electrical circuit containing one or more sources of illumination mounted peripherally on the front, indicia-bearing sign portion, a power source, and a switch for activating the circuit.

U.S. Pat. No. 5,493,292 discloses a traffic control signal adapted for alternate one-way traffic situations in highway construction zones whereby STOP and SLOW sign panels can be alternately displayed. U.S. Pat. No. 5,986,576 discloses a remote-control portable traffic signaling system including a device connected to a power source for controlling a flow of traffic comprising a signal head including a display means for communicating a message. U.S. Pat. No. 6,118,388 discloses a portable traffic light assembly that provides a temporary means for directing traffic during power outages or special events.

### Outline of Basic & Other Advantageous Features

It would be desirable to provide a portable, temporary or the like of a type disclosed in the present application that includes any one or more of these or other advantageous features:

is a portable wireless traffic control device;

is a remotely operated control device;

is easily assembled and disassembled;

is readily stored in a vehicle; and

is durable and able to withstand harsh weather.

These and other features and advantages of various embodiments of systems and methods according to this invention are described in, or are apparent from, the following detailed description of various exemplary embodiments of various devices, structures, and/or methods according to the present disclosure.

### SUMMARY

Accordingly, to fulfill the need, an embodiment of the invention is a portable wireless traffic light assembly that can be operated with a remote control means from a safe distance to turn on a select light to illuminate a selected sign with an added advantage of a combination of colored light and sign.

An exemplary embodiment relates to a portable wireless traffic-control device, comprising: a vertical support; a base adapted for attachment to a first end of the vertical support; a display module adapted for attachment to a second end of the vertical support, the display module comprising one or more sign faces; a plurality of lights on each sign face; a receiver to receive a signal from a remote device; an electrical power source; a circuit connecting the electrical power source, receiver, and plurality of lights; and a processor for receiving input from the receiver and controlling the plurality of lights.

Another exemplary embodiment relates to a portable wireless traffic-control signal system, comprising: one or more traffic-control devices, comprising: a vertical support; a base adapted for attachment to a first end of the vertical support; a display module adapted for attachment to a second end of the vertical support, the display module comprising one or more sign faces; a plurality of lights on each sign face; a receiver to receive a signal from a remote device; an electrical power source; a circuit connecting the electrical power source, receiver, and plurality of lights; and a processor for receiving input from the receiver and controlling the plurality of lights.

These and other features and advantages of various embodiments of systems and methods according to this invention are described in, or are apparent from, the following detailed description of various exemplary embodiments of various devices, structures, and/or methods according to the present disclosure.

### BRIEF DESCRIPTION OF THE DRAWINGS

Various exemplary embodiments of the systems and methods according to the present disclosure will be described in detail, with reference to the following figures, wherein:

FIG. 1 is a perspective view of an exemplary embodiment of a two-way portable traffic control device according to the present disclosure;

FIG. 2 is a perspective view of the base of the embodiment of FIG. 1;

FIG. 3 is a plan view of the support pole of the embodiment of FIG. 1;

FIG. 4 is a front view of a first embodiment of the display module of the embodiment of FIG. 1;

FIG. 5 is a front view of a second embodiment of the display module of the embodiment of FIG. 1;

FIG. 6 is a perspective view of a first exemplary embodiment of a four-way portable wireless traffic control device according to the present disclosure;

FIG. 7 is a perspective view of a second embodiment of a four-way portable wireless traffic control device according to the present disclosure; and

FIG. 8 is a schematic view of an exemplary embodiment of a circuit for a portable wireless traffic control device according to the present disclosure.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION OF THE EXEMPLARY EMBODIMENTS

The present disclosure relates to a portable wireless traffic control signaling device that is primarily intended for temporary placement and use. It is also designed for remote operation. The disclosed portable traffic signal is suited for use in a variety of locations and situations including, but not limited to, school crossings, parades, handicapped crossing or parking, police activities, broken traffic lights, accident scenes (whether or not in an intersection), road construction zones, cattle crossings, parking garages or lots and major events such as concerts, sporting events, auto shows, and other large gatherings. The disclosed device is adapted for placement in or adjacent to traffic pathways with automated control or manual control with a remote controller (e.g., a wireless device). The disclosed device, in various embodiments, may be designed to display in two or four directions.

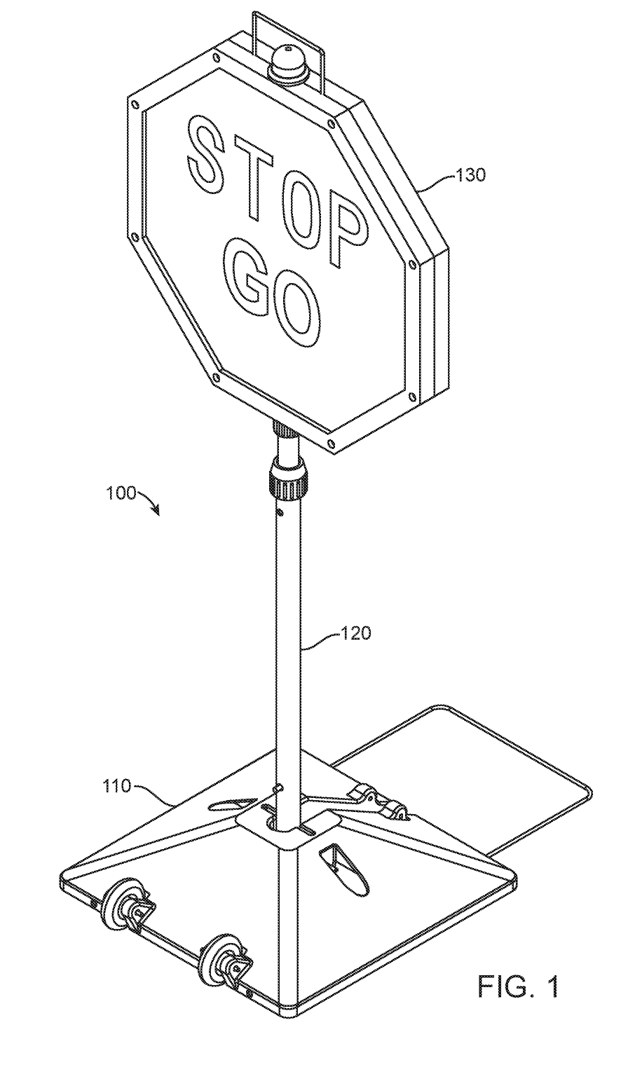

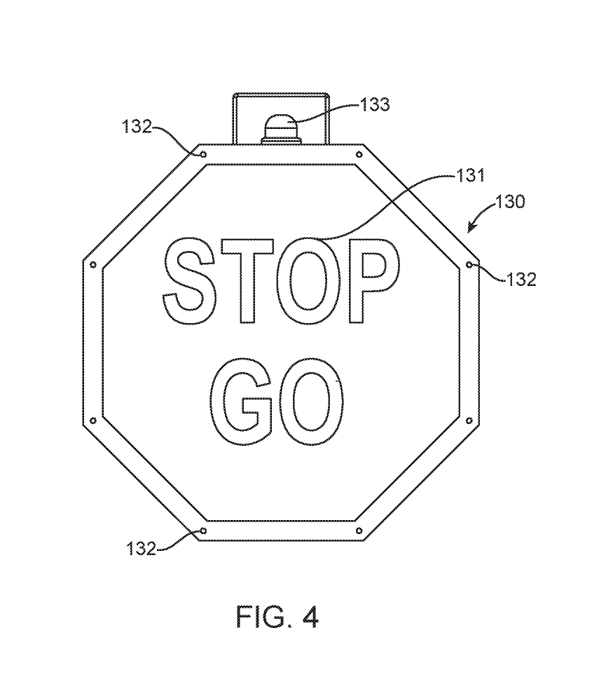

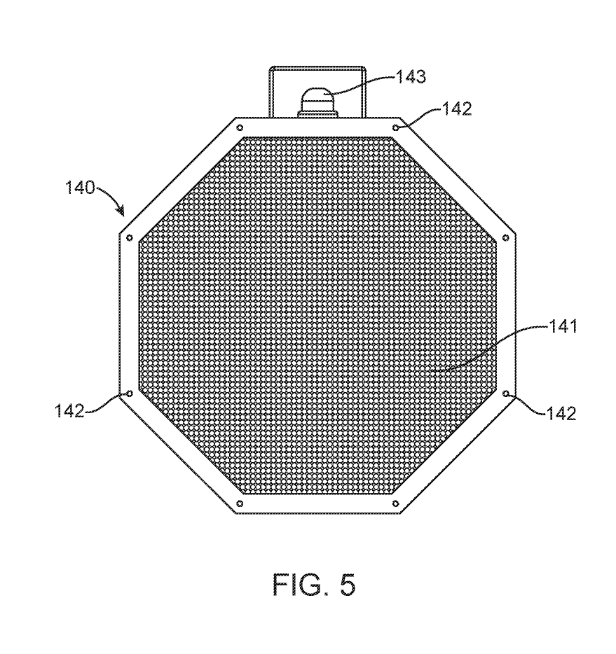

Referring to FIGS. 1-5, an exemplary embodiment of a portable wireless traffic control device 100 includes a base 110 designed to attach to a vertical support 120 and a two-way display module 130 adapted for placement on top of the vertical support 120. In a preferred embodiment, as illustrated in FIG. 4, the display module 130 is designed to give instructions to drivers (e.g., GO, SLOW, and/or STOP) by illuminating these words on the display. In a preferred embodiment, the words GO, SLOW, and/or STOP are illuminated in the familiar green, amber, and red colors, respectively. In another embodiment, as illustrated in FIG. 5, the display module 130 includes an array of lights 131 capable of being selectively illuminated to display instructions such as GO, SLOW, or STOP as well as other instructions or information. In various embodiments, the vertical support 120 comprises two or more telescoping sections allowing for more compact storage and/or adjusting the vertical position of the display module 130.

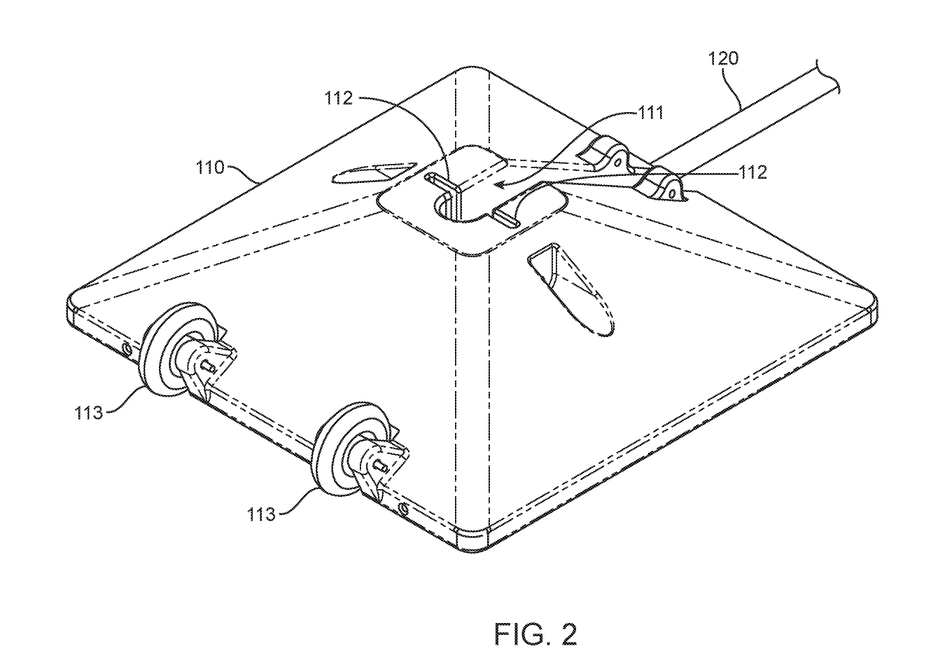

Referring to FIG. 2, an exemplary embodiment of a base 110 is shown. In a preferred embodiment, the base 110 includes a channel 111 and slots 112 adapted for insertion of a vertical support 120. In a preferred embodiment the base 110 and vertical support 120 are adapted for easy and simple disconnection and/or are pivotally attached so that the vertical support can be positioned in an upright position (see FIG. 1) and a horizontal position (see FIG. 2) for storage. In a preferred embodiment, the base 110 includes wheels 113 positioned such that they are not in contact with the ground when the base 110 rests on the ground but will contact the ground when the base is tilted toward the wheels 113.

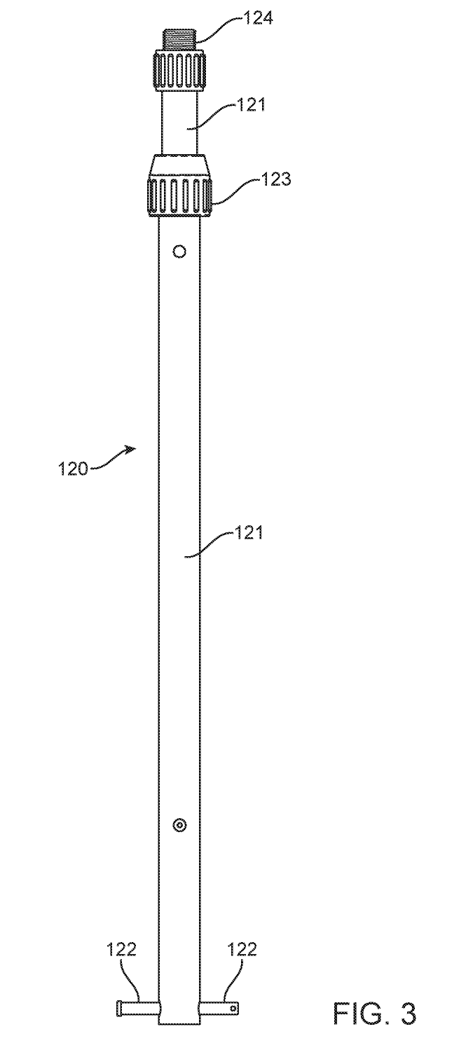

Referring to FIG. 3, an exemplary embodiment of a vertical support 120 is shown. In a preferred embodiment, the vertical support 120 comprises two or more poles 121 in a telescoping relationship. In a preferred embodiment, the vertical support 120 includes one or more locking mechanisms 123 for holding two poles 121 in a constant position relative to each other. In a preferred embodiment, the vertical support 120 includes at least one pin 122 positioned and adapted to fit into slots 112 when the vertical support 120 is inserted into channel 111. In a preferred embodiment, the vertical support 120 is adapted to be readily attached to and detached from the display module 130, 140. In the embodiment of FIG. 3, the vertical support 120 includes a threaded end 124 that screws into the bottom of display module 130, 140.

Referring to FIG. 4, an exemplary embodiment of a one-way or two-way display module 130 is shown. In a preferred embodiment, the display module 130 includes one or more lights or arrays of lights 131 in the shape of one or more letters forming words (e.g., GO, SLOW, and/or STOP). In such an embodiment, the LED arrays 131 preferably display the words GO, SLOW, and STOP in the familiar green, amber, and red colors, respectively. In a preferred embodiment, the lights 131 comprise a plurality of light emitting diodes (hereinafter “LED” or “LEDs”). In a preferred embodiment, the display module 130 includes a plurality of flashing lights 132. In a preferred embodiment, the display module 130 includes a warning light 133. In one embodiment, the warning light 133 is preferably amber in color and begins blinking on and off prior to the display module switching from display or illuminating “GO” to “STOP” for a prescribed time (e.g., 7 seconds). In another embodiment, the warning light 133 is constantly blinking to attract the attention of approaching drivers and/or pedestrians to the portable wireless traffic control device 100.

Referring to FIG. 5, another exemplary embodiment of a one-way or two-way display module 140 is shown. In a preferred embodiment, the display module 140 includes at least one array of lights 141. In a preferred embodiment, the light array 141 comprise a plurality of LEDs. In such an embodiment, the LEDs may be illuminated individually such that a portion of the LEDs are selectively illuminated to display words and/or images. In such an embodiment, the arrays 141 can display single words such as GO, SLOW, or STOP. In such an embodiment, the arrays 141 can display single words such as GO, SLOW, STOP, YIELD, etc. In a preferred embodiment, the words GO, SLOW, or STOP are displayed in the familiar green, amber, and red colors, respectively. In a preferred embodiment, the display module 140 includes a plurality of flashing lights 142. In a preferred embodiment, the display module 140 includes a warning light 143. In one embodiment, the warning light 143 is preferably amber in color and begins blinking on and off prior to the display module switching from display or illuminating “GO” to “STOP” for a prescribed time (e.g., 7 seconds). In another embodiment, the warning light 143 is constantly blinking to attract the attention of approaching drivers and/or pedestrians to the portable wireless traffic control device 100.

In a preferred embodiment, the display module 140 may be able to display other text including, but not limited to, speed limits, vehicle speed, road conditions, or other warnings. In a preferred embodiment, the LED array(s) 141 can display images in place of or in addition to words. Such images would include, but not be limited to, standard road signs such as yield signs, traffic lights, stop signs, lane closure or merging signs, etc. (including borders) as defined in the Manual (Manual on Uniform Traffic Control Devices), which is incorporated herein by reference in its entirety.

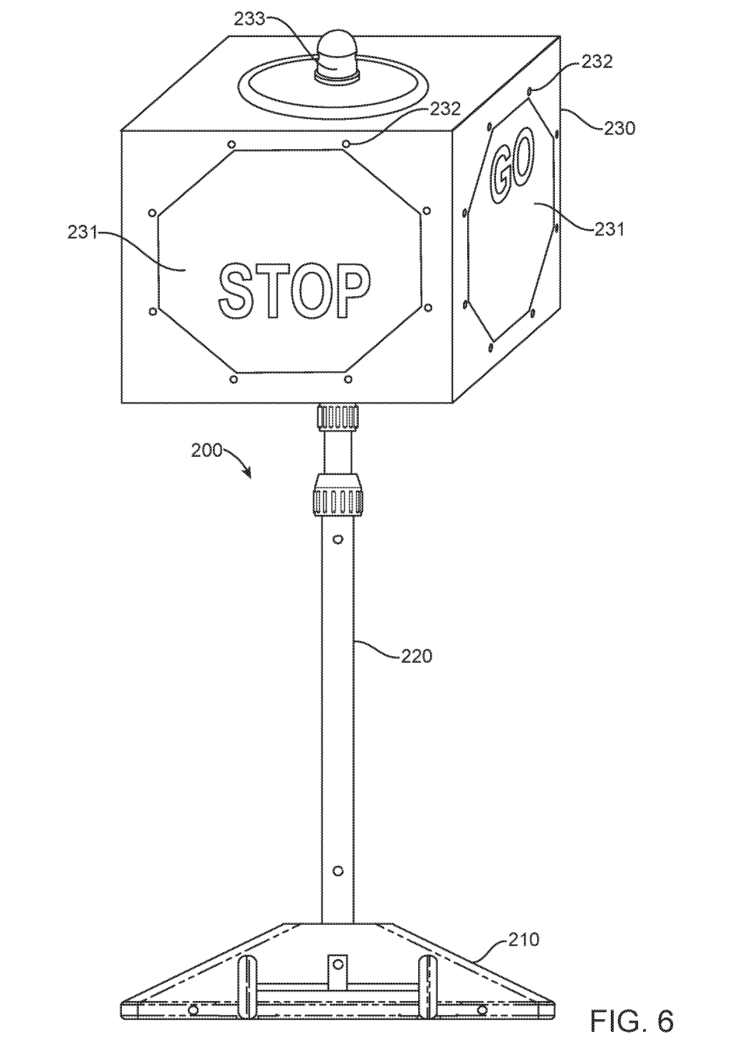

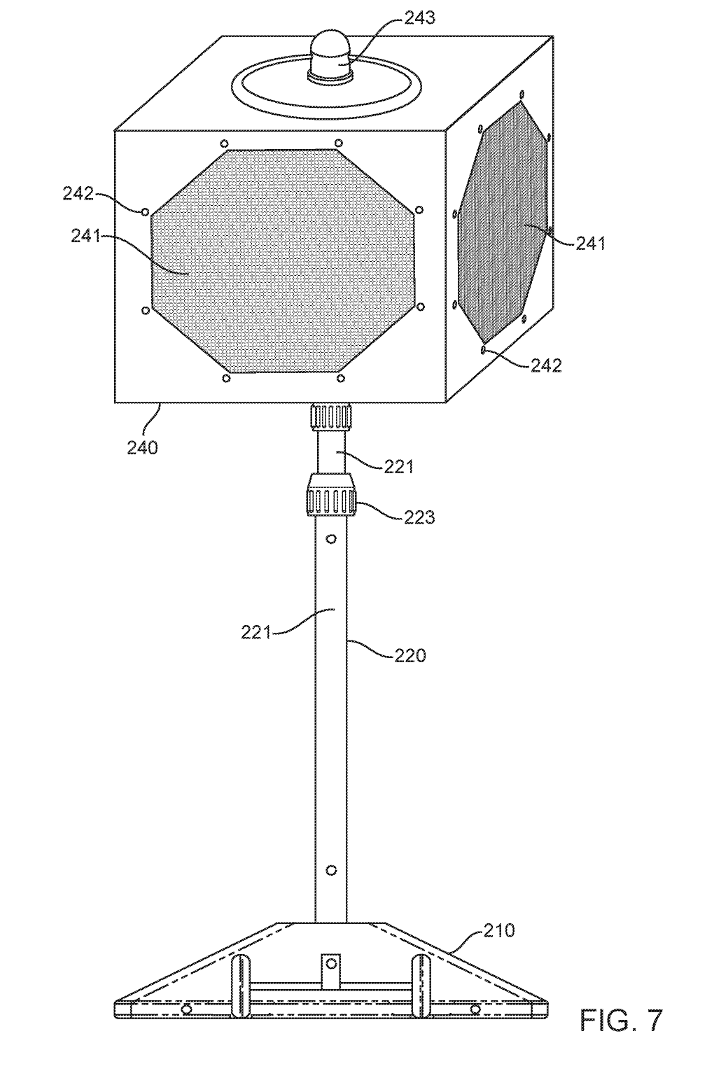

Referring to FIGS. 6 and 7, an exemplary embodiment of a portable wireless traffic control device 200 includes a base 210 designed to attach to a vertical support 220 and a four-way display module 230, 240 adapted for placement on top of the support pole. In various embodiments, the base 210 has the characteristics of base 110 as described above and shown in FIG. 2. In various embodiments, the vertical support 220 has the characteristics of vertical support 120 as described above and shown in FIG. 3.

Referring to FIG. 6, an exemplary embodiment of a four-way portable wireless traffic control device 200 is shown. In a preferred embodiment, an exemplary embodiment of a one-way or two-way display module 230 is shown. In a preferred embodiment, the display module 230 includes one or more lights or arrays of lights 231 in the shape of one or more letters forming words (e.g., GO, SLOW, and/or STOP). In such an embodiment, the LED arrays 231 preferably display the words GO, SLOW, and STOP in the familiar green, amber, and red colors, respectively. In a preferred embodiment, the lights 231 comprise a plurality of light emitting diodes (hereinafter “LED” or “LEDs”). In a preferred embodiment, the display module 230 includes a plurality of warning lights 232. In one embodiment, the warning lights 232 are preferably amber in color and begin blinking on and off prior to the display module switching from display or illuminating “GO” to “STOP” for a prescribed time (e.g., 7 seconds). In another embodiment, the warning lights 232 are constantly blinking to attract the attention of approaching drivers and/or pedestrians to the portable wireless traffic control device 200. In a preferred embodiment, the display module 230 includes a warning light 233. In one embodiment, the warning light 233 is preferably amber in color and begins blinking on and off prior to the display module switching from display or illuminating “GO” to “STOP” for a prescribed time (e.g., 7 seconds). In another embodiment, the warning light 233 is constantly blinking to attract the attention of approaching drivers and/or pedestrians to the portable wireless traffic control device 200.

Referring to FIG. 7, another exemplary embodiment of a one-way or two-way display module 240 is shown. In a preferred embodiment, the display module 240 includes at least one array of lights 241. In a preferred embodiment, the light array 241 comprise a plurality of LEDs. In such an embodiment, the LEDs may be illuminated individually such that a portion of the LEDs are selectively illuminated to display words and/or images. In such an embodiment, the arrays 241 can display single words such as GO, SLOW, or STOP. In such an embodiment, the arrays 241 can display single words such as GO, SLOW, STOP, YIELD, etc. In a preferred embodiment, the words GO, SLOW, or STOP are displayed in the familiar green, amber, and red colors, respectively. In another embodiment, the warning lights 242 are constantly blinking to attract the attention of approaching drivers and/or pedestrians to the portable wireless traffic control device 200. In a preferred embodiment, the display module 240 includes a warning light 243. In one embodiment, the warning light 243 is preferably amber in color and begins blinking on and off prior to the display module switching from display or illuminating “GO” to “STOP” for a prescribed time (e.g., 7 seconds). In another embodiment, the warning light 243 is constantly blinking to attract the attention of approaching drivers and/or pedestrians to the portable wireless traffic control device 200.

In a preferred embodiment, the display module 240 may be able to display other text including, but not limited to, speed limits, vehicle speed, road conditions, or other warnings. In a preferred embodiment, the LED array(s) 241 can display images in place of or in addition to words. Such images would include, but not be limited to, standard road signs such as yield signs, traffic lights, stop signs, lane closure or merging signs, etc. (including borders) as defined in the Manual (Manual on Uniform Traffic Control Devices).

In a preferred embodiment, the portable wireless traffic control device 100, 200 includes a power source capable of providing an electrical current. The power source may be a power generator, such as a solar panel, and/or a power storage device, such as a capacitor or an electrochemical battery. In a preferred embodiment, the power storage device is capable of being repeatedly recharged after its charge is depleted.

In various preferred embodiments, the LED arrays 131, 141, 231, 241 can illuminate as a steady light or flashing on and off repeatedly. In various preferred embodiments, the LED arrays 131, 141, 231, 241 comprise LEDs each capable of illuminating in two or more colors.

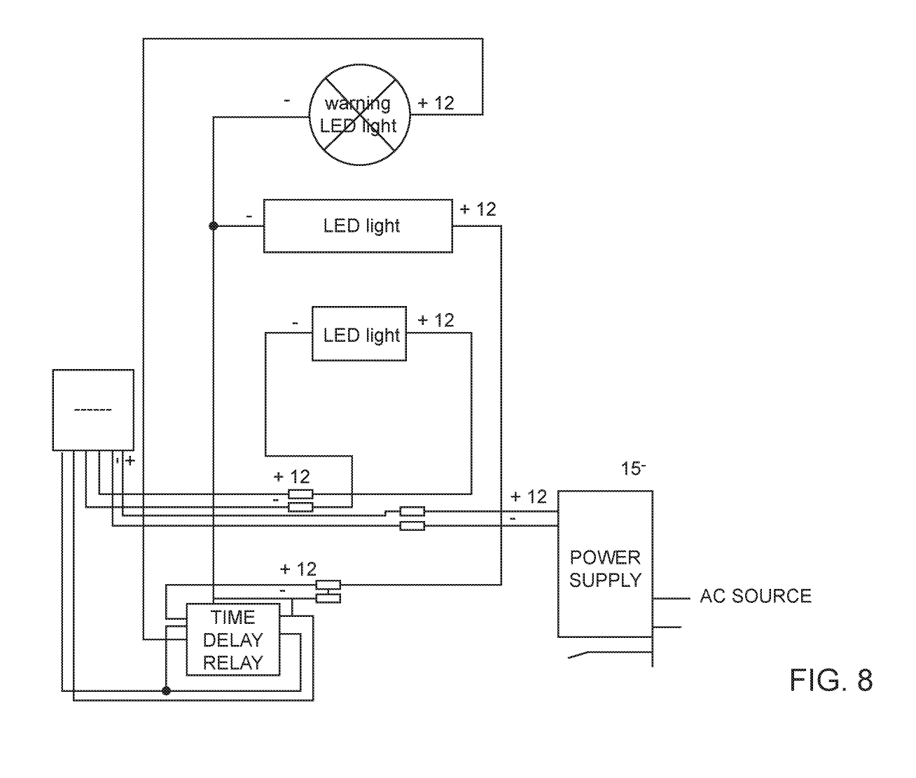

Referring to FIG. 8, an exemplary embodiment of control circuitry is shown. The circuitry is designed so that the portable wireless traffic-control devices do not show different signal at the same time (e.g., STOP and GO simultaneously lit).

In a preferred embodiment, the disclosed system includes two or more portable wireless traffic-control devices 100, 200. Each traffic control device 100, 200 is placed for optimal viewing by vehicle drivers and/or pedestrians approaching a controlled area (e.g., on opposite sides of the road at a crosswalk, at different corners of an intersection, or at the opposite ends of a construction zone). In such an embodiment, the traffic control devices 100, 200 are preferably all connected (e.g., wirelessly) to a single remote-control device. In such an embodiment, the traffic control devices 100, 200 are configured for consistent signaling (e.g., crossing traffic not indicated to enter an intersection at the same time).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be appreciated that the construction and arrangement of the portable wireless traffic control signaling device, as shown in the various exemplary embodiments, is illustrative only. While the portable wireless traffic control signaling device, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the portable traffic control signaling device, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

What is claimed is:

1. A portable wireless traffic-control device, comprising:
a vertical support;
a base adapted for attachment to a first end of the vertical support;
a display module adapted for attachment to a second end of the vertical support, the display module comprising one or more sign faces;
a plurality of lights on each sign face;
a receiver to receive a signal from a remote device;
an electrical power source;
a circuit connecting the electrical power source, receiver, and plurality of lights; and
a processor for receiving input from the receiver and controlling the plurality of lights.

2. The portable wireless traffic-control device of claim 1 wherein the plurality of lights comprises a plurality of light emitting diodes.

3. The portable wireless traffic-control device of claim 1 wherein the plurality of lights comprises:
at least one light with a first color; and
at least one light with a color other than the first color.

4. The portable wireless traffic-control device of claim 1 wherein the plurality of lights comprises at least one light capable of illuminating in two or more different colors.

5. The portable wireless traffic-control device of claim 1 wherein the remote device communicates wirelessly with the traffic-control device.

6. The portable wireless traffic-control device of claim 1 wherein the power source comprises a battery.

7. The portable wireless traffic-control device of claim 1 wherein the power source comprises a solar panel.

8. The portable wireless traffic-control device of claim 1 further comprising a flashing warning light.

9. The portable wireless traffic-control device of claim 1 further comprising a remote-control device having a transmitter for sending a signal to the receiver.

10. The portable wireless traffic-control device of claim 1 wherein the vertical support comprises one or more sections of telescoping poles.

11. A portable wireless traffic-control signal system, comprising:
one or more traffic-control devices, comprising:
a vertical support;
a base adapted for attachment to a first end of the vertical support;
a display module adapted for attachment to a second end of the vertical support, the display module comprising one or more sign faces;
a plurality of lights on each sign face;
a receiver to receive a signal from a remote device;
an electrical power source;
a circuit connecting the electrical power source, receiver, and plurality of lights; and
a processor for receiving input from the receiver and controlling the plurality of lights.

12. The portable wireless traffic-control signal system of claim 11 wherein the plurality of lights comprises a plurality of light emitting diodes.

13. The portable wireless traffic-control signal system of claim 11 wherein the plurality of lights comprises:
at least one light with a first color; and
at least one light with a color other than the first color.

14. The portable wireless traffic-control signal system of claim 11 wherein the plurality of lights comprises at least one light capable of illuminating in two or more different colors.

15. The portable wireless traffic-control signal system of claim 11 wherein the remote device communicates wirelessly with the traffic-control device.

16. The portable wireless traffic-control signal system of claim 11 wherein the power source comprises a battery.

17. The portable wireless traffic-control signal system of claim 11 wherein the power source comprises a solar panel.

18. The portable wireless traffic-control signal system of claim 11 wherein the one or more traffic-control devices further comprise a flashing warning light.

19. The portable wireless traffic-control signal system of claim 11 wherein the one or more traffic-control devices further comprise a remote-control device having a transmitter for sending a signal to the receiver.

20. The portable wireless traffic-control signal system of claim 11 wherein the vertical support comprises one or more sections of telescoping poles.
